(19) United States
(12) Patent Application Publication
(10) Pub. No.: US 2011/0227302 A1
(43) Pub. Date: Sep. 22, 2011

(54) Low Profile Transformable Creeper

(75) Inventors: Peter Gillespie, Raytown, MO (US); Lyman Alan Thurmon, Independence, MO (US); Colin Michael Mandrick, Kansas City, MO (US); Ryan Jorgensen, Blue Springs, MO (US)

(73) Assignee: Shinn Fu Company of America, Inc.

(21) Appl. No.: 13/038,310

(22) Filed: Mar. 1, 2011

Related U.S. Application Data
(63) Continuation-in-part of application No. 29/357,731, filed on Mar. 16, 2010, now Pat. No. D639638.
Application No. 29/357,731 is a continuation-in-part of application No. 29/357,738, filed on Mar. 16, 2010, now Pat. No. D634502.
(60) Provisional application No. 61/375,122, filed on Aug. 19, 2010.

(51) Int. Cl. B25H 5/00

(52) U.S. Cl. 280/32.6

(57) ABSTRACT

One transformable creeper includes three portions. The first portion has a frame, four wheels operatively coupled to the frame such that a lower edge of the frame is maintained above a lowermost point of the four wheels by no more than about two thirds the diameter of the four wheels, and a first support surface operatively coupled to the frame. The second portion has a second frame rotatably coupled to the frame and a second support surface. A lock maintains the second frame at three angles relative to the frame (generally 180°; between about 90° and 180°; and between 0° and 90°). The third portion has a third frame rotatably coupled to the second frame, two wheels, and a third support surface. A lock respectively maintains the third frame at two angles relative to the second frame (generally 180°, and between 0° and 90°).

### CROSS-REFERENCE TO RELATED APPLICATIONS

This application claims priority to U.S. Provisional Application No. 61/375,122 filed Aug. 19, 2010, and is also a continuation-in-part of U.S. Patent Application No. 29/357,731 filed Mar. 16, 2010, and U.S. Patent Application No. 29/357,738 filed Mar. 16, 2010, the disclosures of all which are incorporated herein by reference.

### BACKGROUND OF THE INVENTION

The invention relates generally to the field of creepers. More specifically, the invention relates to the field of transformable creepers.

### SUMMARY

In one embodiment, a transformable creeper includes first, second, and third portions. The first portion has a first frame, two wheels operatively coupled to one side of the first frame, two wheels operatively coupled to an opposite side of the first frame, and a first support surface operatively coupled to the first frame. Each of the four wheels is operatively coupled to the first frame such that a lower edge of the first frame is maintained above a lowermost point of the four wheels by no more than about two thirds the diameter of the four wheels. The second portion has a second frame and a second support surface operatively coupled to the second frame. The second frame is rotatably coupled to the first frame, and a lock respectively maintains the second frame at three angles relative to the first frame. A first of the three angles is generally one hundred and eighty degrees; a second of the three angles is between about ninety and one hundred and eighty degrees; and a third of the three angles is between zero and ninety degrees. The third portion has a third frame, two wheels operatively coupled to the third frame, and a third support surface operatively coupled to the third frame. The third frame is rotatably coupled to the second frame, and a lock respectively maintains the third frame at two angles relative to the second frame. A first of the two angles is generally one hundred and eighty degrees, and a second of the two angles is between zero and ninety degrees.

In another embodiment, a transformable creeper includes first, second, and third portions. The first portion has a first frame, two wheels operatively coupled to one side of the first frame, two wheels operatively coupled to an opposite side of the first frame, and a first support surface operatively coupled to the first frame. The four wheels operatively coupled to the first frame are arranged such that an imaginary straight line connecting two of the wheels on opposite sides of the first frame passes through the first frame. The second portion has a second frame and a second support surface operatively coupled to the second frame. The third portion has a third frame, two wheels operatively coupled to the third frame, and a third support surface operatively coupled to the third frame. The second frame is rotatably coupled to the first frame, and the third frame is rotatably coupled to the second frame. Means are included for respectively maintaining the second frame at three angles relative to the first frame, and means are included for respectively maintaining the third frame at two angles relative to the second frame. A first of the three angles is generally one hundred and eighty degrees; a second of the three angles is between about ninety and one hundred and eighty degrees; and a third of the three angles is between zero and ninety degrees. A first of the two angles is generally one hundred and eighty degrees, and a second of the two angles is between zero and ninety degrees.

### BRIEF DESCRIPTION OF THE DRAWINGS

Illustrative embodiments of the present invention are described in detail below with reference to the attached drawing figures, wherein:

FIG. 1 is a perspective view of a low profile transformable creeper 100 according to one embodiment, wherein the creeper 100 is shown in a generally horizontal configuration;

FIG. 2 is a side view of the creeper 100 of FIG. 1 in a generally horizontal configuration;

FIG. 3 is an opposite side view of the creeper 100 of FIG. 1 in a generally horizontal configuration;

FIG. 4 is an end view of the creeper 100 of FIG. 1 in a generally horizontal configuration;

FIG. 5 is an opposite end view of the creeper 100 of FIG. 1 in a generally horizontal configuration;

FIG. 6 is a top view of the creeper 100 of FIG. 1 in a generally horizontal configuration;

FIG. 7 is a bottom view of the creeper 100 of FIG. 1 in a generally horizontal configuration;

FIG. 8 is a side view of the creeper 100 of FIG. 1 in a “L” configuration;

FIG. 9 is an opposite side view of the creeper 100 of FIG. 1 in the “L” configuration;

FIG. 10 is a perspective view of the creeper 100 of FIG. 1 in the “L” configuration;

FIG. 11 is a side view of the creeper 100 of FIG. 1 in a “Z” configuration;

FIG. 12 is an opposite side view of the creeper 100 of FIG. 1 in the “Z” configuration;

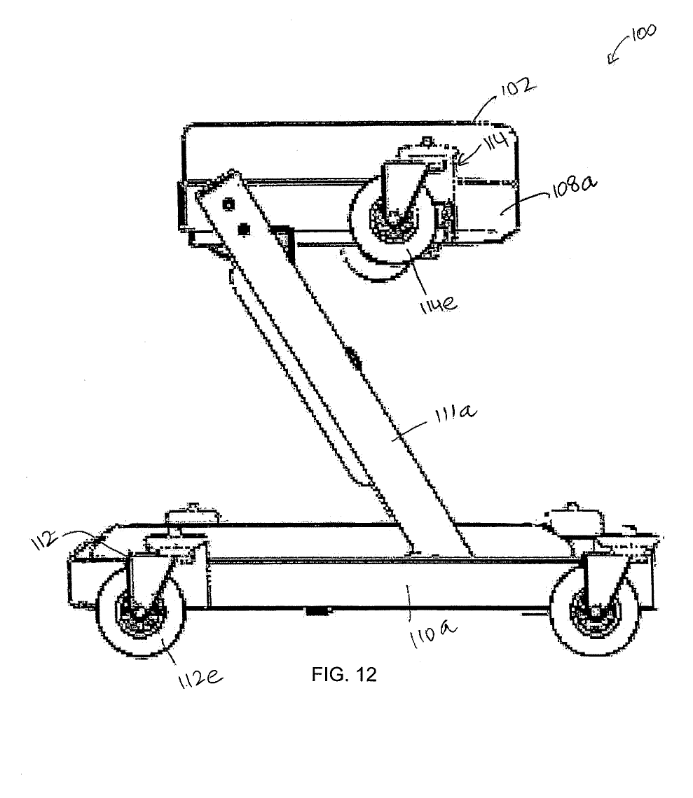

FIG. 13 is a perspective view of the creeper 100 of FIG. 1 in the “Z” configuration;

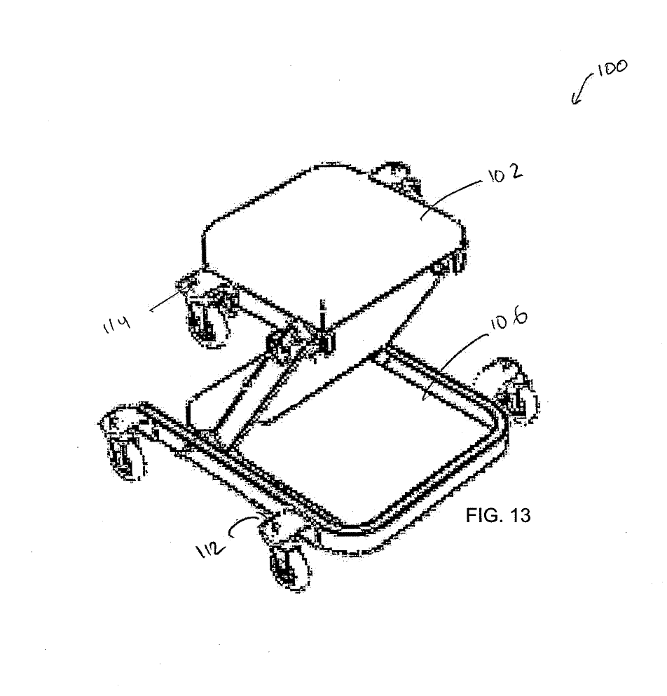

FIG. 14 is similar to FIG. 11, except that caster assemblies 114 are shown folded inwards;

FIG. 15 is an end view of the creeper 100 of FIG. 1 in a “Z” configuration, where the caster assemblies 114 are shown folded inwards;

FIG. 16 shows a first locking mechanism 130 of the creeper 100 of FIG. 1;

FIG. 17 is another view of the first locking mechanism 130 of FIG. 16;

FIG. 18 is a perspective view of an embodiment 200 of a low profile transformable creeper in a generally horizontal configuration;

FIG. 19 is a side view of the creeper 200 of FIG. 18 in a “L” configuration; and

FIG. 20 is a side view of the creeper 200 of FIG. 18 in a “Z” configuration.

### DETAILED DESCRIPTION

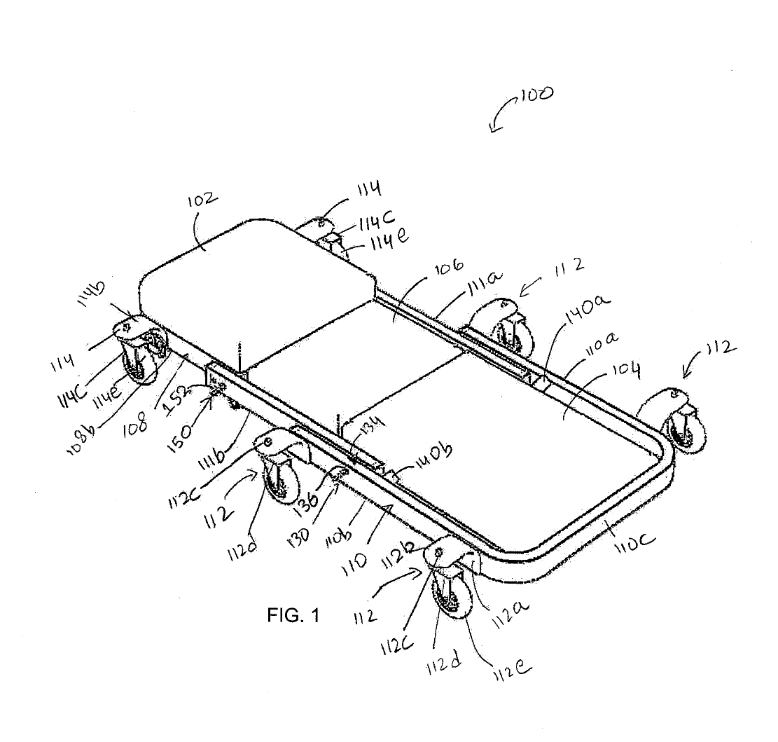

Embodiments of the present invention provide low profile transformable creepers and methods of manufacture and use. With reference to FIG. 1, a low profile transformable creeper 100 has a head rest or pillow 102, a first support surface 104, a second support surface 106, a head rest support member 108, a first support member 110, side rails 111a and 111b, a first locking mechanism 130, and a second locking mechanism 150. It should be appreciated that, while respectively shown and described as unitary elements, the head rest support member 108 and the first support member 110 may alternately include two or more separate elements. Similarly, the side rails 111a, 111b may be portions of a unitary member (e.g., forming a “H” configuration), though shown and described as separate elements. Four outwardly extending caster assemblies 112 (two on either side of the first support surface 104) are secured to the first support member 110. Two hinged, outwardly extending retractable caster assemblies 114 (one on each side of the head rest 102) are secured to the headrest support member 108.

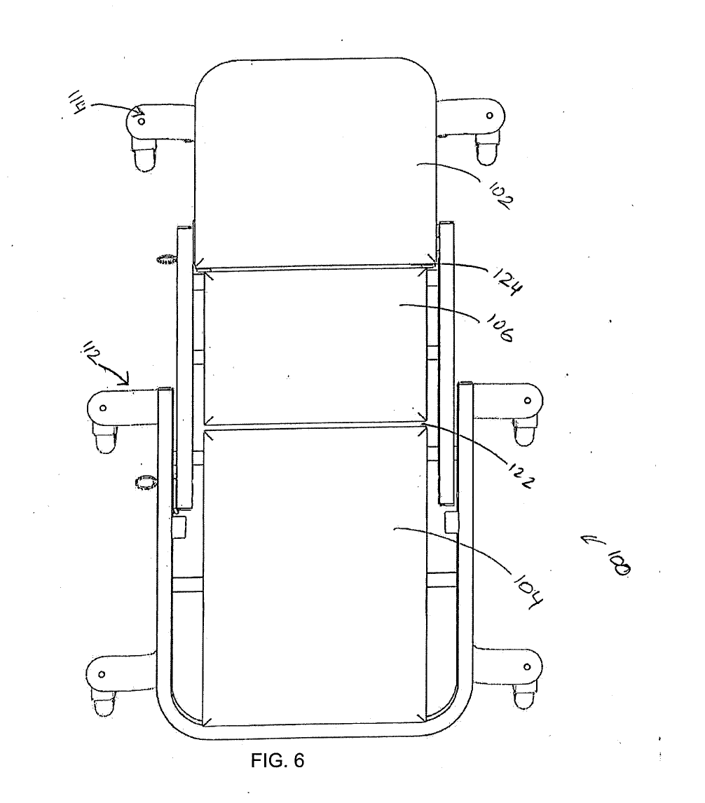

FIG. 1 shows, the transformable creeper 100 in a generally horizontal configuration. In this configuration, the first support surface 104 and the second support surface 106 are generally planar, whereas the headrest 102 is slightly raised in comparison, so as to provide an ergonomically sound platform for a user to lay down on the first and second support surfaces 104, 106 and the headrest 102. The headrest 102 and the support surfaces 104, 106 may be constructed of foam or padded material enclosed by a durable material (e.g., vinyl) to provide an easy-to-clean surface that is also comfortable to lay on. The headrest 102 may be slightly wider than the first and second support surfaces 104, 106 respectively (see FIG. 6), which increases the surface area for a user to sit on when the creeper 100 is in a “Z” configuration, as discussed in more detail below.

The first support member 110 is U-shaped with two legs 110a, 110b and a connecting member 110c generally perpendicular to the legs 110a, 110b as shown in FIG. 1. Two of the four outwardly extending caster assemblies 112 are secured to leg 110a, and the other two outwardly extending caster assemblies 112 are secured to leg 110b. Those skilled in the art will appreciate that additional caster assemblies 112 may be included, and some embodiments may include as few as three caster assemblies 112 operatively coupled to the first support member 110.

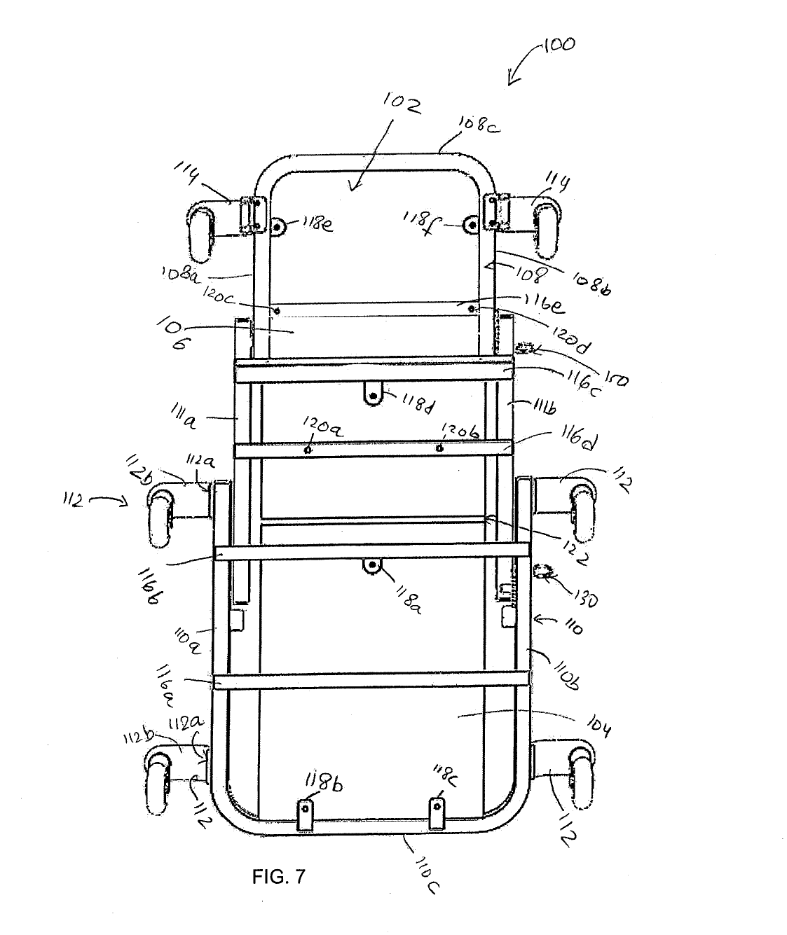

Two transverse cross members 116a, 116b (FIG. 7) extend between and are secured to the underside of legs 110a, 110b of the first support member 110. The transverse cross members 116a, 116b may be spaced apart so as to properly distribute and support the weight of the first support surface 104, and a user laying thereon. The cross members 116a, 116b may be welded to the legs 110a, 110b of the first support member 110, or may be secured to the first support member legs 110a, 110b via other known methods, such as by bolts or screws. A bracket 118a that allows for the passage of a screw or lock therethrough may be secured to the cross member 116b at or near the center of the cross member 116b. Two load bearing brackets 118b, 118c allowing for the passage of a screw or bolt therethrough may also be secured to the connecting member 110c of the first support member 110, and may generally be equidistant from the bracket 118a. The first support surface 104 rests on the cross members 116a, 116b, and the brackets 118a, 118b, 118c, and the support surface 104 is held firmly in place via bolts or screws extending through the brackets 118a, 118b, and 118c. In some embodiments, the bracket 118a may not exist as a separate element; instead, a hole may be present in the cross member 116b, through which a bolt or screw can be passed to secure the first support surface 104 to the cross member 116b. And, though not shown, the members 116a, 116b could alternately be a single member, or three or more members, and adhesive or other fasteners may secure the first support surface 104.

Two transverse cross members 116c, 116d may similarly extend between and are secured to the side rails 111a, 111b (FIG. 7). Cross member 116c may have one (or more) bracket 118d, and cross member 116d may have two holes 120a, 120b. The bracket 118d and holes 120a, 120b allow for the passage of bolts or screws so as to secure the second support surface 106 to the cross members 116c, 116d. Adhesive or other fasteners may alternately, or additionally, be used to secure the second support surface 106 to the cross members 116c, 116d. The cross members 116c, and 116d may be spaced apart so as to properly distribute and support the weight of the second support surface 106 and a user laying thereon, and the distance between bracket 118d and hole 120a, and bracket 118d and hole 120b may be generally the same. While not shown, the transverse cross members 116c, 116d could alternately be a single member, or three or more members. A slight gap 122 (FIG. 6) may be between the first support surface 104 and the second support surface 106 to allow the creeper 100 to be transformed into “L” and “Z” configurations, as discussed in more detail below.

Similar to the first support member 110, the headrest support member 108 may also be U-shaped, with two legs 108a, 108b and a connecting member 108c, although the headrest support member 108 may generally be smaller in size than the first support member 110 (FIG. 7). A transverse cross member 116e may extend between the legs 108a, 108b of the headrest support member 108, and have two holes 120c, 120d that allow for the headrest 102 to be secured to the cross member 116e via screws, bolts, et cetera. Additionally, two load bearing brackets 118e, 118f may be secured (e.g., welded, bolted, etc.) to the legs 108a, 108b of the headrest support member 108, and have holes through which screws or bolts can be inserted to further secure the headrest 102 to the headrest support member 108. Three corresponding edges of headrest 102 may be placed, and rest on the legs 108a, 108b, and the connecting member 108c of the headrest support member 108; thus, the weight of the headrest 102 and a user laying thereon may be supported by the cross member 116e, the brackets 118e, 118f, the legs 108a, 108b, and the connecting member 108c. Akin to gap 122, there may be a slight gap 124 between the headrest 102 and the second support member 106, as shown in FIG. 6.

It is often desirable for a user of creepers to be able to maneuver while being as low to the ground as possible (e.g., when doing vehicle wheel alignments). Generally, however, creepers have wheels that extend directly underneath the creeper's frame and increase the required clearing distance of the creeper's frame with respect to the ground. But the four outwardly extending caster assemblies 112 associated with the first supporting member 110, instead of extending underneath the first supporting member 110, may instead extend outward from the first supporting member 110. In the embodiment of caster assembly 112 shown throughout the drawings, each caster assembly 112 has a connecting portion 112a, an outwardly extending portion 112b, and a wheel 112e (see FIG. 1). The connecting and outwardly extending portions 112a, 112b may individually and collectively have various aesthetic configurations, but allowing the caster assembly 112 to attach to structure (e.g., the first supporting member 110) beside—instead of above—the wheel 112e may allow the attached structure (e.g., the first supporting member 110) to be maintained lower to a ground surface than would otherwise generally be feasible.

The connecting portions 112a of two caster assemblies 112 are secured to the leg 110a such that the outwardly extending portions 112b of those caster assemblies 112 extend away from the leg 110b (see FIG. 7). Similarly, the connection portions 112a of two other caster assemblies 112 are secured to the leg 110b such that the outwardly extending portions 112b of those caster assemblies 112 extend away from the leg 110a. The spacing between the two caster assemblies 112 on leg 110a may be generally the same as the spacing between the two caster assemblies 112 on leg 110b, and such configuration may allow for even distribution of weight and desirable maneuverability of the creeper 100.

The outwardly extending portions 112b of the caster assemblies 112 may each have a hole, through which a bolt 112c or other structural member can be passed through, so as to secure a wheel mounting bracket 112d to each outwardly extending portion 112b. A respective wheel 112e is secured to the wheel mounting bracket 112d of each of the four caster assemblies 112. The wheels 112e can rotate within their respective mounting brackets 112d about an axis and allow a user of the creeper 100 to conveniently move and reposition the creeper 100. Moreover, the wheel mounting brackets 112d may themselves be movable (e.g., rotatable about the bolts 112c), and can align themselves at different angles depending on the direction in which a user wants to move the creeper 100. By virtue of the caster assemblies 112, (and 114 as discussed in more detail below), a user may maneuver the creeper 100 relatively close to a ground surface and maintain a desirably low clearance from the ground.

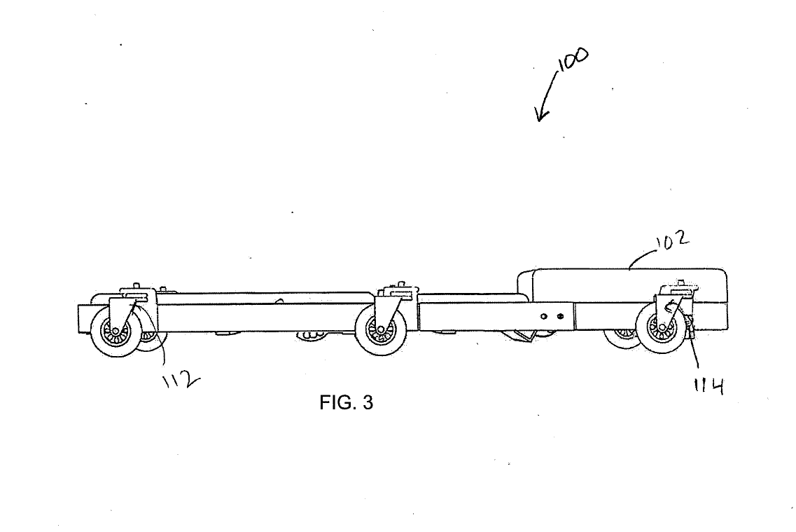

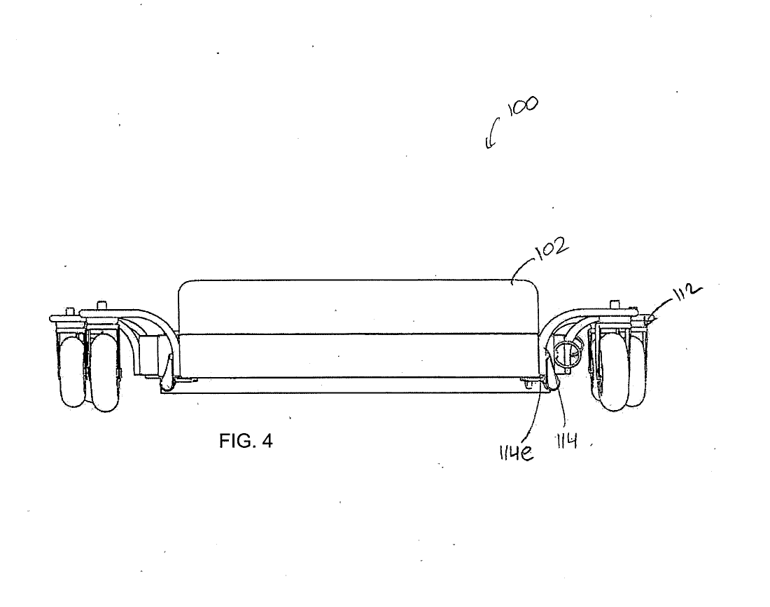

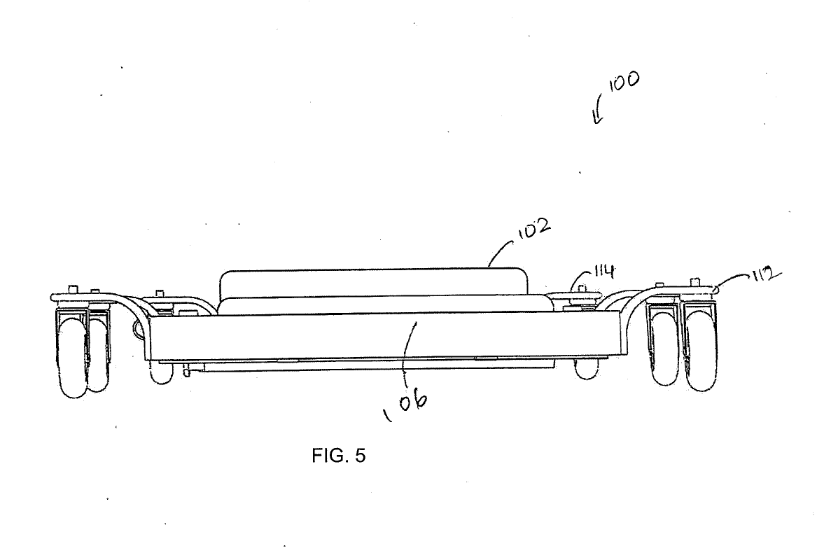

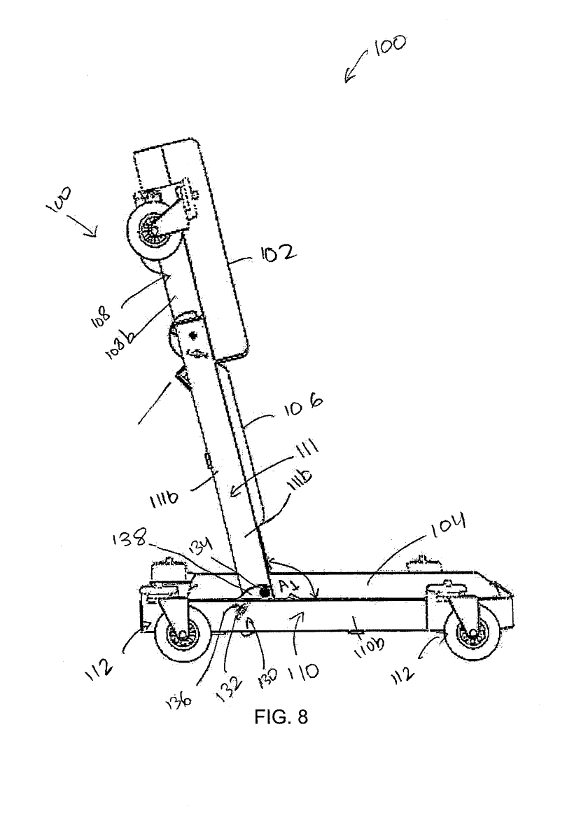

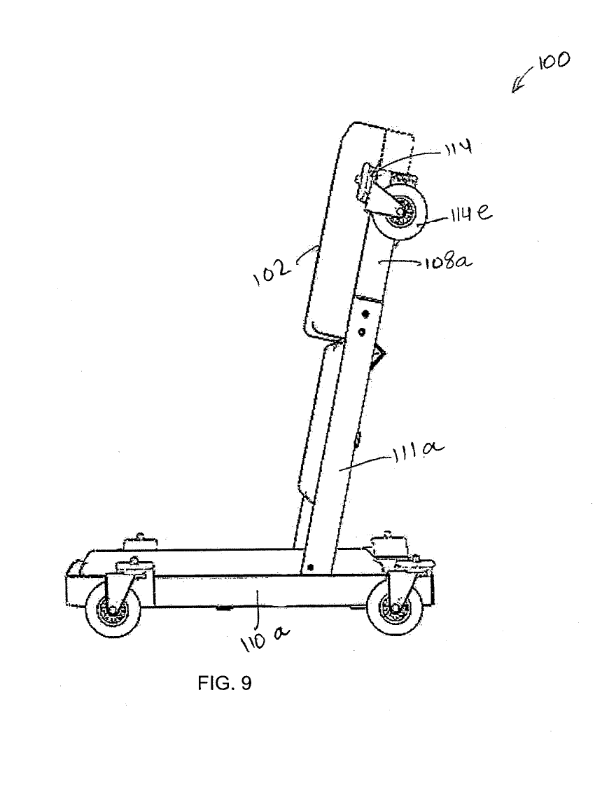

In addition to the generally horizontal configuration depicted in FIGS. 1-7, the creeper 100 can also be transformed into an “L” configuration, as shown in FIGS. 8-10. The “L” configuration provides a comfortable but easily maneuverable chair; more specifically, a user may sit on the first support surface 104, rest his/her back against the second support surface 106, and rest his/her back or head against the headrest 102. In the “L” configuration, it may be desirable for an angle A1 between the leg 110b of the first supporting member 110 and the side rail 111b to be slightly greater than 90 degrees, so as to provide for an ergonomically-sound back support for the user.

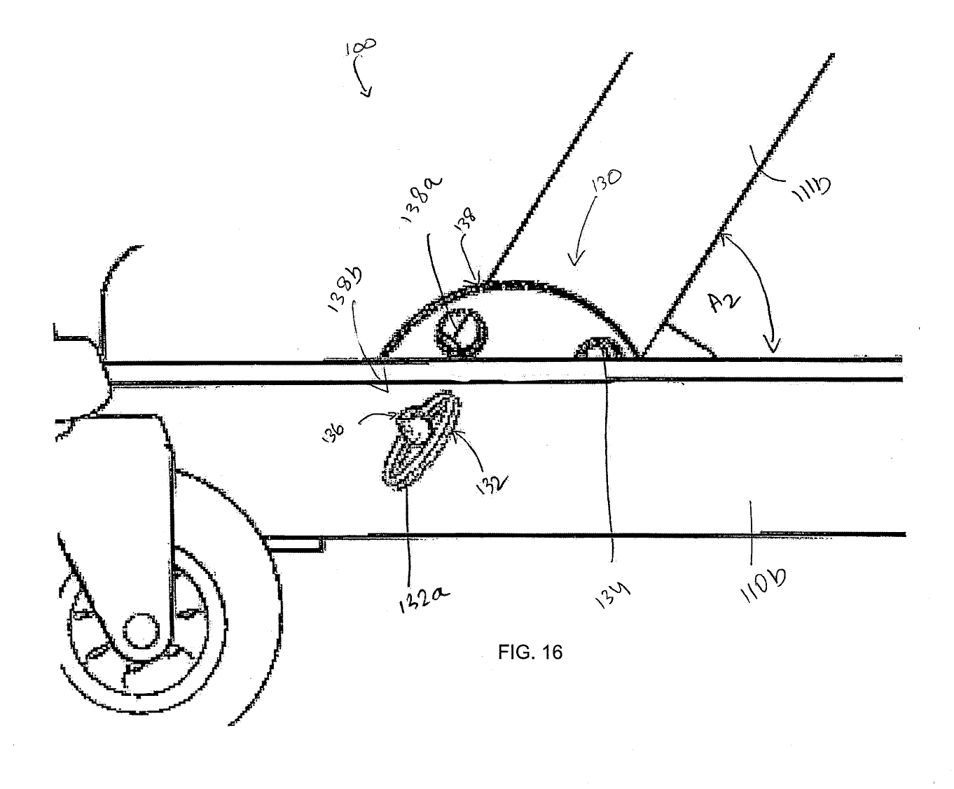

To effectuate the transformation from the horizontal configuration to the “L” configuration, a user may alter the interaction of the first locking mechanism 130 (FIGS. 8, 11, 16 and 17) from a first locked position to a second locked position. With reference to FIG. 8, one embodiment of the first locking mechanism 130 has a spring pin 132, which may for example be generally cylindrical, passing through a hole 136 in the leg 110b of the first support member 110. And at one end, the spring pin 132 may have a hollow ring 132a (FIG. 16) to allow the spring pin 132 to be pulled with a user's finger. The side rail 111b has a hole 134 (FIG. 16) through which the spring pin 132 can pass when at the first locked position, and the spring pin 132 passes through the hole 134 when the creeper 100 is at the generally horizontal configuration (FIGS. 1-7). By passing through the hole 134, the spring pin 132 locks the side rail 111b to the leg 110b of the first supporting member 110, such that the side rails 111a and 111b generally cannot be moved with respect to the first supporting member 110, and the creeper 100 is fixed in the horizontal configuration.

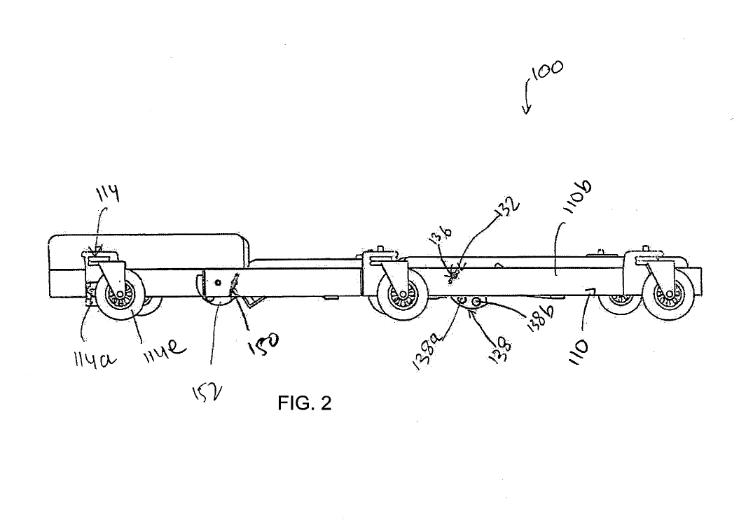

An extension (e.g., semi-circular locking member 138) may be secured to the side rail 111b (FIGS. 2 and 8), or the side rail 111b may be dimensioned such that an extension is not necessary. The locking member 138 of the embodiment 100 has at least two holes 138a, 138b (FIG. 16) which are configured for the passage of the spring pin 132 therethrough. As discussed above, to lock the creeper 100 in the horizontal configuration, the spring pin 132 is passed through the hole 134 in the side rail 111b (or the hole 134 may be formed in the locking member 138). To change from the horizontal configuration (FIGS. 1 through 7) to the “L” configuration (FIGS. 8 through 10), the spring pin 132 is disengaged from the side rail 111b at the hole 134. With the spring pin 132 disengaged, the side rails 111a, 111b may be freely rotated in unison with respect to the first supporting member 110; each side rail 111a, 111b may pivot along bolts, etc. that secure the side rails 111a, 111b to the first supporting member legs 110a, 110b. As the side rails 111a and 111b are rotated such that they move away from the ground and the first supporting member 110, the locking member 138 also rotates. This movement of the locking member 138 causes the hole 138a, which was previously underneath the pin 132 (FIG. 2), to align with and correspond to the pin 132; more specifically, when the angle between the side rail 111b and the leg 110b of the first support member 110 is A1 (FIG. 8), the pin 132 corresponds with—and passes through—the hole 138a of the locking member 138. By passing through the hole 138a, the spring pin 132 locks the creeper 100 in the “L” configuration.

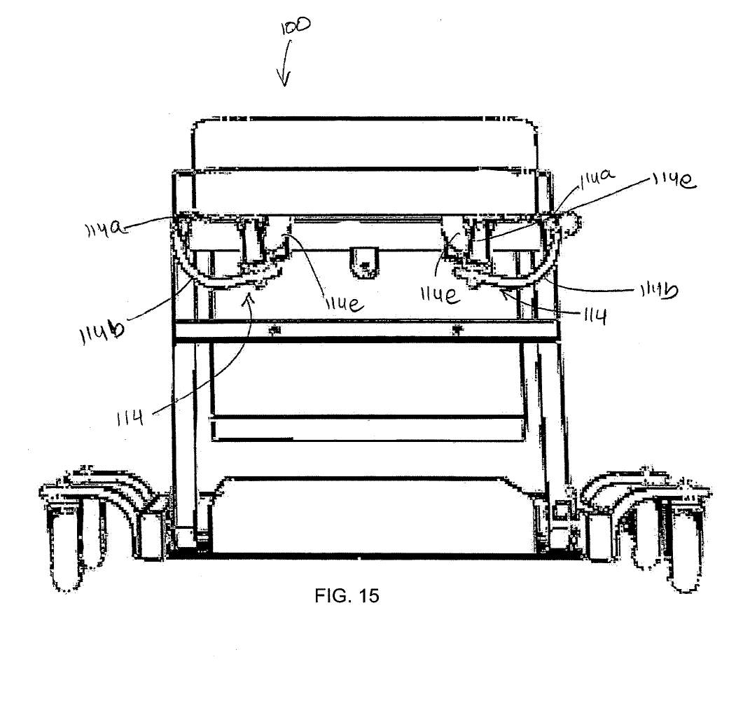

As the user sits on the creeper 100 in the “L” configuration, the movement of the user's arms/elbows may be impeded by the two hinged, outwardly extending retractable caster assemblies 114 that are secured to the headrest support member 108. To eliminate this potential impediment, both of the caster assemblies 114 can be retracted such that they fold underneath the headrest 102 (see FIG. 15, wherein the caster assemblies 114 are retracted, albeit when the creeper 100 is in a “Z” configuration, as discussed below). More specifically, each retractable caster assembly 114 has a hinge 114a (FIG. 2), an outwardly extending portion 114b (FIG. 1), and a wheel 114e that can rotate within a bracket 114c that is secured to the outwardly extending portion 114b. Much like the four wheels 112e, the two wheels 114e, in addition to rotating within (and relative to) the bracket 114c, can rotate along with the bracket 114c to allow the creeper 100 to be easily maneuvered. But, when the creeper 100 is in the “L” or the “Z” configuration (i.e., when the wheels 114e are not in contact with the ground or other such surface), each caster assembly 114 can be pivoted on the respective hinge 114a and rotated inward, such that the outwardly extending portions 114b and the wheel 114e rest below the headrest 102 and out of the way of a user.

In addition to maintaining generally horizontal and “L” configurations, the creeper 100 may also be configured to provide a seat that is raised in a “Z” configuration. To transform the creeper 100 from the horizontal or the “L” configuration into the “Z” configuration, the spring pin 132 may be pulled outward (i.e., away from the side rail 111b), which allows the side rails 111a, 111b to respectively pivot along the bolts (or other members) that secure the side rails 111a, 111b to the legs 110a, 110b. Thus, akin to when the creeper 100 is being transformed from the horizontal configuration to the “L” configuration, the side rail 111b is rotated upwardly away from the leg 110b of the first supporting member 110. But here, the side rails 111a, 111b are rotated past the angle A1 (FIG. 8) to an angle A2 (FIG. 16); the angle A2 between the leg 110b of the first support surface and the side rail 111b is generally less than 90 degrees. When the angle A2 is formed, the hole 138b is aligned with the spring pin 132, and the spring pin 132 passes through the hole 138b to lock the side rails 111a, 111b at the angle A2 (and the “Z” configuration).

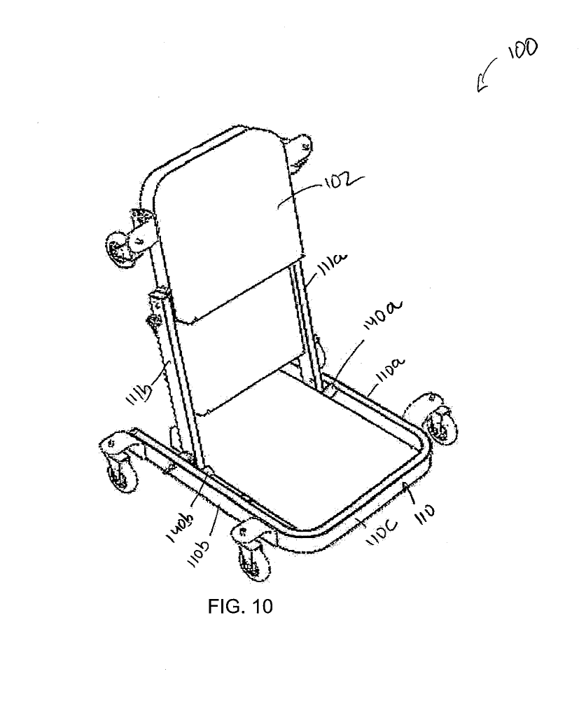

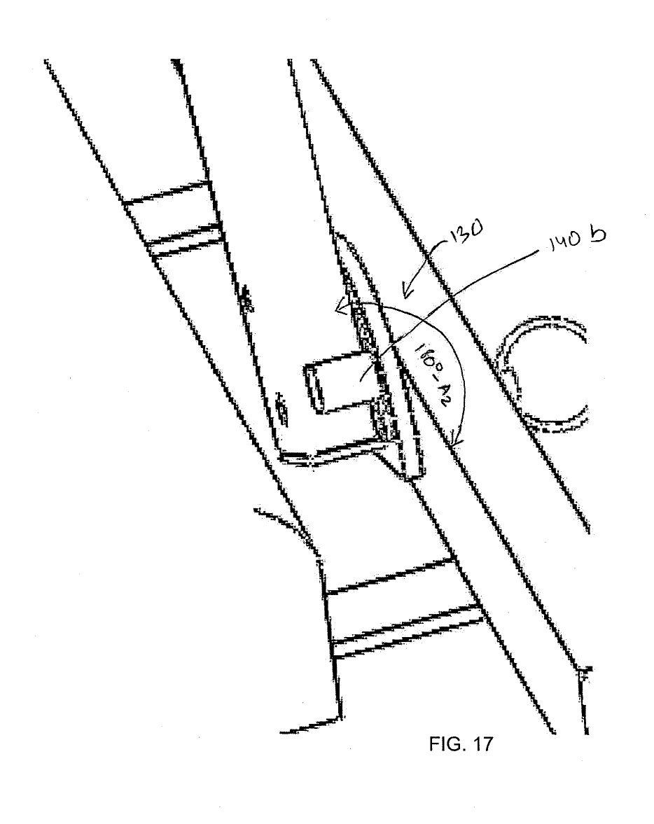

To further ensure that the side rails 111a, 111b are securely locked at the angle A2, the legs 110a, 110b of the first support member 110 may each have a protruding stop 140a, 140b respectively (FIGS. 1 and 17). The stops 140a, 140b are strategically secured (e.g., welded, bolted, etc.) to the respective legs 110a, 110b such that they do not interfere when the creeper 100 is in the horizontal configuration, nor obstruct the transformation of the creeper 100 from the horizontal configuration to the “L” configuration (see FIG. 1 showing the stops 140a, 140b being some distance away from the side rails 111a, 111b in the horizontal configuration; see FIG. 10 showing the stops 140a, 140b being some distance away from the side rail 111a, 111b in the “L” configuration). In the “Z” configuration, however, the stops 140a, 140b may stop (and support) the side rails 111a, 111b respectively, and prevent the side rails 111a, 111b from forming an angle smaller than A2.

Once the side rails 111a, 111b are locked (via the spring pin 132 and the stops 140a, 140b) at the angle A2, the creeper 100 is maintained in an “intermediate-Z” position. Instead of the “L” configuration, where the headrest 102 and the second support member 106 are generally planar and the angle A1 is formed between the leg 110b and side rail 111b, in the “intermediate-Z” configuration, the headrest 102 and the second support member 106 remain planar, but now the angle A2 is formed between the leg 110b and the side rail 111b. To finish the transformation from the “intermediate-Z” position to the “Z” configuration, the second locking mechanism 150 (FIG. 1) is utilized.

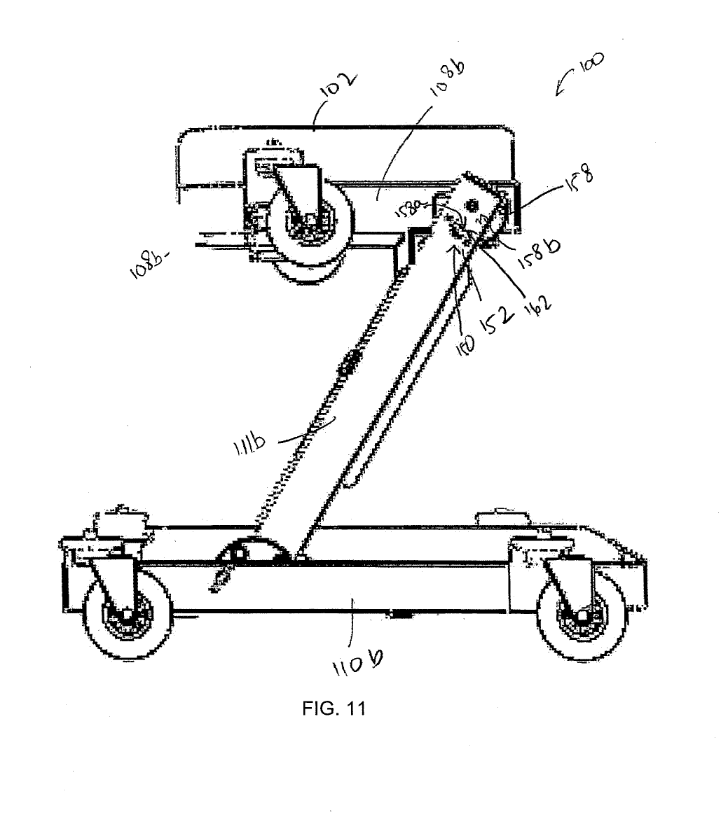

The second locking mechanism 150 may include a spring pin 152 passing through a hole 162 at the end of the side rail 111b adjacent the leg 108b. And, akin to the locking member 138, an extension (e.g., locking member 158) may be operatively coupled to the leg 108b of the headrest support member 108 (or the support member 108 may be dimensioned such that the extension 158 is unnecessary). Although the view of the locking member 158 is often obstructed by the side rail 111b in the figures, it will be appreciated that the locking member 158 (or the support member 108) has two holes 158a, 158b which are configured to receive the spring pin 152 (FIG. 11).

In the “intermediate-Z” position, the “L” configuration, or the horizontal configuration, the headrest support member 108 is held in place by the spring pin 152, which is locked within the hole 158b in the leg 108b of the headrest support member 108. To transform the creeper 100 into the “Z” configuration, after moving the creeper 100 to the “intermediate-Z” position, the spring pin 152 is pulled out of hole 158b and the headrest 102 is pushed downward such that it generally becomes parallel to the ground or other such surface (and generally parallel to the first support surface 104).

At this position (i.e., the “Z” configuration), the spring pin 152 passes through the holes 158a, thereby locking the headrest 102 in a position where it is generally parallel to the first support member 104 (FIG. 11). In addition to being locked into place by the spring pin 152, the headrest support member 108 may rest on the transverse cross members 116b to provide additional and adequate support for a user to safely sit on the headrest 102. As noted above, it will be appreciated by those skilled in the art that instead of including the locking member 158, the leg 108b of the headrest support member 108 may itself have two openings or holes which serve the same purpose as the holes 158a, 158b of the locking member 158.

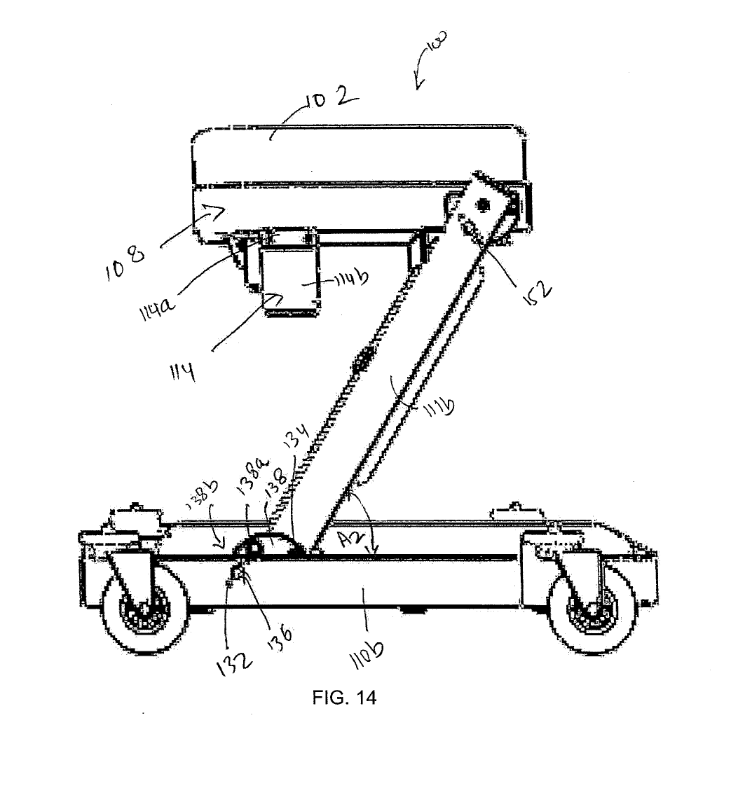

As with the “L” configuration, the outwardly extending caster assemblies 114 can be retracted and set underneath the headrest support member 108 by pivoting the outwardly extending portions 114b along the hinges 114a. This is shown in FIGS. 14 and 15 and may prevent the caster assemblies 114 from obstructing a user's movements.

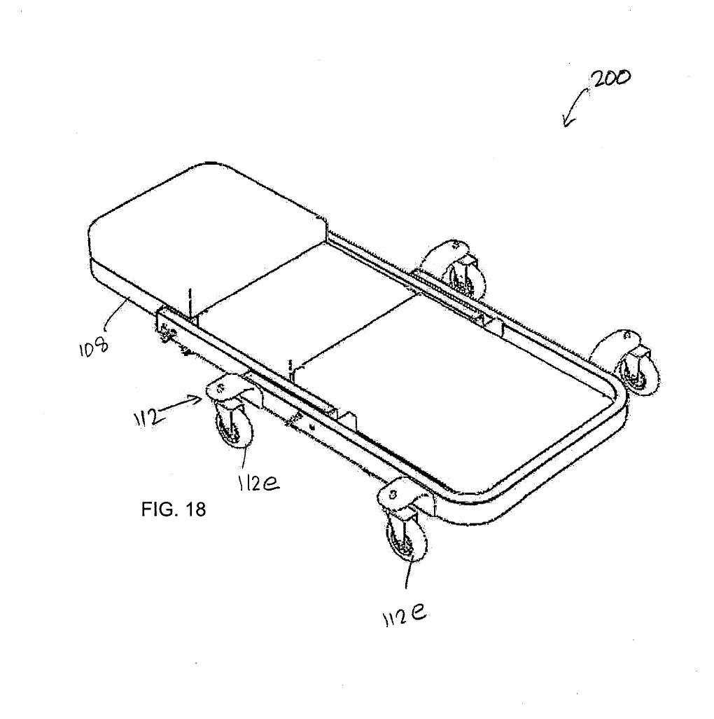

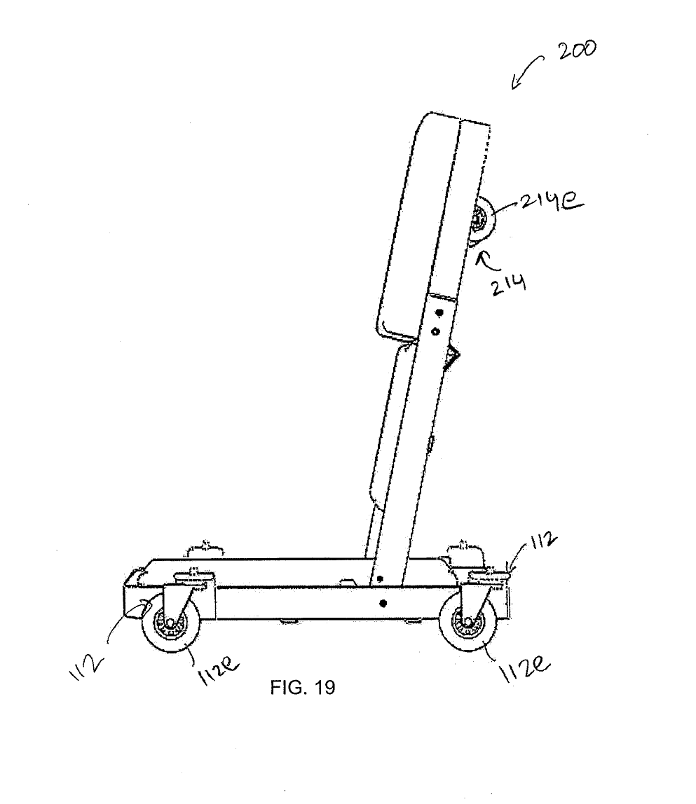

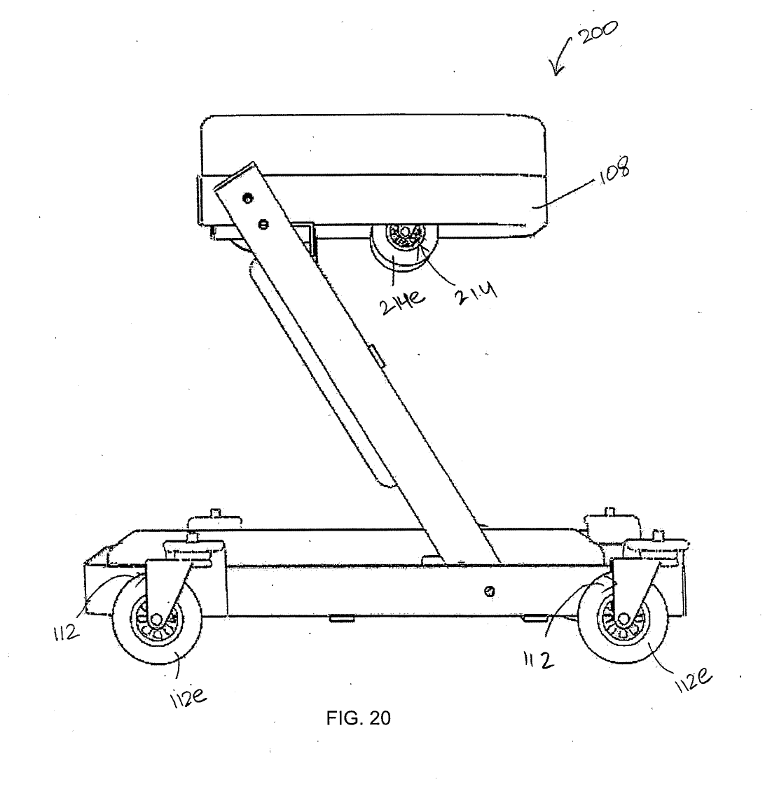

FIGS. 18-20 show another embodiment 200 of the creeper that is substantially similar to embodiment 100, except as specifically noted and/or shown, or as would be inherent. For uniformity and brevity, corresponding reference numbers may be used to indicate corresponding parts, though with any noted deviations. The major difference between embodiments 100, 200 is that embodiment 200 does not have two retractable caster assemblies 114 that extend outward from the headrest support member 108; instead, the embodiment 200 has two caster assemblies 214 which are fixed underneath the headrest support member 108, as shown in FIGS. 19 and 20. Wheels 214e of caster assemblies 214 may be smaller than the wheels 112e of caster assemblies 112 in embodiment 200 (see FIG. 20), allowing the creeper 200 to remain low to the ground in the horizontal and the “L” configurations. Nevertheless, the larger wheels 112e may still be used in the caster assemblies 112, allowing some advantages of the larger wheels to be achieved. By eliminating the retractable caster assemblies 114 and hinges 114a, it may be possible to manufacture the embodiment 200 in a more cost-effective manner than the embodiment 100, though the objective of keeping the caster assemblies and wheels out of a user's way may be met in both embodiments 100, 200. The transformation of the creeper 200 between the horizontal configuration and the “L” and “Z” configurations may be accomplished in generally the same manner as the transformations of the creeper 100.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims.

We claim:

1. A transformable creeper, comprising:
a first portion having a first frame, two wheels operatively coupled to one side of the first frame, two wheels operatively coupled to an opposite side of the first frame, and a first support surface operatively coupled to the first frame; the four wheels operatively coupled to the first frame being arranged such that an imaginary straight line connecting two of the wheels on opposite sides of the first frame passes through the first frame;
a second portion having a second frame and a second support surface operatively coupled to the second frame; the second frame being rotatably coupled to the first frame;
means for respectively maintaining the second frame at three angles relative to the first frame; a first of the three angles being generally one hundred and eighty degrees; a second of the three angles being between about ninety and one hundred and eighty degrees; a third of the three angles being between zero and ninety degrees;
a third portion having a third frame, two wheels operatively coupled to the third frame, and a third support surface operatively coupled to the third frame; the third frame being rotatably coupled to the second frame; and
means for respectively maintaining the third frame at two angles relative to the second frame; a first of the two angles being generally one hundred and eighty degrees; a second of the two angles being between zero and ninety degrees.

2. The transformable creeper of claim 1, wherein each of the four wheels operatively coupled to the first frame has an upper end that is generally aligned with an upper end of the first frame.

3. The transformable creeper of claim 1, wherein the second frame includes a pair of generally parallel side rails.

4. The transformable creeper of claim 1, wherein at least six wheels are operatively coupled to the first frame.

5. The transformable creeper of claim 1, wherein the two wheels operatively coupled to the third frame are respectively movable from positions adjacent the third frame to positions behind the third frame.

6. The transformable creeper of claim 1, further comprising a stop coupled to the first frame for interacting with the second frame when the second frame is at the third of the three angles; wherein the first frame has a lower edge; wherein the stop is positioned above the first frame lower edge; and wherein the second frame sits atop the stop when the second frame is at the third of the three angles.

7. The transformable creeper of claim 6, wherein each of the four wheels operatively coupled to the first frame has an upper end that is above the first frame lower edge.

8. The transformable creeper of claim 7, wherein the means for respectively maintaining the second frame at three angles relative to the first frame includes a spring pin and three receiving holes.

9. The transformable creeper of claim 8, wherein the means for respectively maintaining the third frame at two angles relative to the second frame includes a spring pin and two receiving holes.

10. The transformable creeper of claim 9, wherein each of the four wheels operatively coupled to the first frame is respectively rotatable about at least two axes.

11. The transformable creeper of claim 10, wherein the entire second frame extends adjacent or above the first frame lower edge when the second frame is maintained at the second of the three angles, when the second frame is maintained at the third of the three angles, and when the second frame is moved between the three angles.

12. The transformable creeper of claim 11, further comprising a locking member extending from the second frame, and wherein at least one of the three receiving holes is formed in the locking member.

13. A transformable creeper, comprising:
a first portion having a first frame, four wheels operatively coupled to the first frame, and a first support surface operatively coupled to the first frame; wherein each of the four wheels is operatively coupled to the first frame such that a lower edge of the first frame is maintained above a lowermost point of the four wheels by no more than about two thirds the diameter of the four wheels;
a second portion having a second frame and a second support surface operatively coupled to the second frame; the second frame being rotatably coupled to the first frame;
a lock respectively maintaining the second frame at three angles relative to the first frame; a first of the three angles being generally one hundred and eighty degrees; a second of the three angles being between about ninety and one hundred and eighty degrees; a third of the three angles being between zero and ninety degrees;
a third portion having a third frame, two wheels operatively coupled to the third frame, and a third support surface operatively coupled to the third frame; the third frame being rotatably coupled to the second frame; and
a lock respectively maintaining the third frame at two angles relative to the second frame; a first of the two angles being generally one hundred and eighty degrees; a second of the two angles being between zero and ninety degrees.

14. The transformable creeper of claim 13, wherein each of the four wheels is operatively coupled to the first frame such that a lower edge of the first frame is maintained above a lowermost point of the four wheels by no more than about one half the diameter of the four wheels.

15. The transformable creeper of claim 14, further comprising a stop coupled to the first frame for interacting with the second frame when the second frame is at the third of the three angles; wherein the stop is positioned above the first frame lower edge; and wherein the second frame sits atop the stop when the second frame is at the third of the three angles.

16. A transformable creeper, comprising:
a first portion having a first frame, a plurality of first wheels operatively coupled to the first frame, and a first support surface operatively coupled to the first frame; wherein each of the first wheels is operatively coupled to the first frame such that a lower edge of the first frame is maintained below an uppermost point of the first wheels;
a second portion having a second frame and a second support surface operatively coupled to the second frame; the second frame being rotatably coupled to the first frame;
a third portion having a third frame, a second wheel operatively coupled to the third frame, and a third support surface operatively coupled to the third frame; the third frame being rotatably coupled to the second frame;
a lock respectively maintaining the second frame at a plurality of angles relative to the first frame; and
a lock respectively maintaining the third frame at a plurality of angles relative to the second frame.

17. The transformable creeper of claim 16, wherein each of the first wheels is operatively coupled to the first frame such that the first frame lower edge is maintained above a lowermost point of the first wheels by no more than about half the diameter of the first wheels.

18. The transformable creeper of claim 17, wherein the plurality of angles relative to the first frame and the plurality of angles relative to the second frame allow: (a) the first frame and the third frame to be generally parallel in at least two different configurations, and (b) the first frame, the second frame, and the third frame to be generally parallel in at least one configuration.

19. The transformable creeper of claim 18, wherein another second wheel is operatively coupled to the third frame.

20. The transformable creeper of claim 19, wherein an outer diameter of the second wheels is generally the same as or less than an outer diameter of the first wheels; and further comprising a stop coupled to the first frame, the second frame sitting atop the stop when the second frame is at one of the angles relative to the first frame, the first and second frames being non-parallel when the second frame sits atop the stop.
